(19) United States
(12) Patent Application Publication
(10) Pub. No.: US 2015/0090548 A1
(43) Pub. Date: Apr. 2, 2015

(54) CYLINDER DEVICE AND MANUFACTURING METHOD THEREFOR

(71) Applicant: HITACHI AUTOMOTIVE SYSTEMS, LTD., Ibaraki (JP)

(72) Inventor: Teruaki YAMANAKA, Ayase-shi (JP)

(21) Appl. No.: 14/492,593

(22) Filed: Sep. 22, 2014

(30) Foreign Application Priority Data
Sep. 30, 2013 (JP) 204055/2013

(51) Int. Cl. F16F 9/32

(52) U.S. Cl. CPC F16F 9/3271; F16F 9/3221
USPC 188/297; 29/434

(57) ABSTRACT

A lock piston (13) of a locking mechanism (11) includes a flow path limiting-opening mechanism (14) provided on an outer peripheral side of a piston rod (7), an annular stopper (19) for supporting the flow path limiting-opening mechanism (14) from a piston (6) side, and a restriction ring (20) for restricting a fitting cylindrical body (15) of the flow path limiting-opening mechanism (14) from moving to a rod guide (9) side, the restriction ring (20) being fitted to a second annular groove (7B) of the piston rod (7). The restriction ring (20) is inserted along an outer peripheral side of the piston rod (7) from an upper end side of the piston rod (7), and fitted and fixed into the second annular groove (7B).

### BACKGROUND OF THE INVENTION

1. Field of the Invention

The present invention relates to a cylinder device to be mounted to vehicles such as a four-wheeled automobile and is suitably used for clamping vibration of the vehicle, and a manufacturing method for a cylinder device.

2. Description of the Related Art

In general, in vehicles such as a four-wheeled vehicle, a hydraulic shock absorber is interposed as a cylinder device between each wheel (axle side) and a vehicle body so as to reduce vibration of the vehicle (for example, refer to Japanese Utility Model Application Laid-open No. Sho 50-23533, and Japanese Utility Model Examined Publication No. Hei 4-25551). Cylinder devices of this type according to the related art include a hydraulic locking mechanism configured to cause a hydraulic cushioning effect at maximum extension of a piston rod so as to prevent full extension.

By the way, in the cylinder devices according to the related art, at the time of assembling components of the hydraulic locking mechanism to the piston rod by an ordinary method, scratch marks and the like are liable to be formed on an outer peripheral surface of the piston rod (in particular, surface to be held in sliding contact with, for example, a rod guide). As a result, sufficient sealing may not be performed. Meanwhile, there is a problem in that, in order to prevent the piston rod from being scratched, a troublesome and complicated assembly method has to be employed.

### SUMMARY OF THE INVENTION

The present invention has been made in view of the above-mentioned problem with the related art. The present invention provides a cylinder device and a manufacturing method therefore, which enable components of a looking mechanism to be assembled to piston rod with high work efficiency and prevent the formation of scratches and the like.

In order to achieve the above-mentioned object, according to one embodiment of the present invention, there is provided a cylinder device, including: a cylinder in which working fluid is sealed; a piston that is inserted to be slidable in the cylinder and divides an inside of the cylinder; a piston rod that is coupled to the piston; a rod guide for guiding the piston rod in a slidable manner by allowing the piston rod to be inserted through the rod guide, the rod guide being mounted to the cylinder; and a locking mechanism that is actuated when the piston rod extends to reach a full extension position of the cylinder, in which the locking mechanism includes: a lock piston that is provided on the piston rod on the rod guide side with respect to the piston; and a look cylinder portion that is provided in the cylinder on a projecting end side of the piston rod and is provided to allow the lock piston to be slidably inserted through the lock cylinder portion, in which the lock piston includes: a flow path limiting-opening mechanism for limiting a flow path when the lock piston moves into the lock cylinder portion, and opening the flow path when the lock piston moves out of the lock cylinder portion; a piston-side fixing portion for supporting the flow path limiting-opening mechanism from the piston side, the piston-side fixing portion being provided on an outer peripheral side of the piston rod; and an annular rod-guide-side fixing member for restricting the flow path limiting-opening mechanism from moving to the rod guide side, the annular rod-guide-aide fixing member being fitted in a groove that is formed along the piston rod, and in which the annular rod-guide-side fixing member includes one of a resin and a rubber at least on an inner peripheral side of the annular rod-guide-side fixing member so as to enable the annular rod-guide-side fixing member to be inserted in sliding contact with the piston rod.

Of those, the annular rod-guide-side fixing member may include a radially shrinkable and expandable ring made of a metal material, the radially shrinkable end expandable ring being inserted along the piston rod with a gap on an inner peripheral side of the radially shrinkable and expandable ring, and being fitted into the groove by being pressed in a radial direction.

According to one embodiment of the present invention, a manufacturing method for a cylinder device includes: fixing the piston-side fixing portion to the piston, rod after inserting the piston-side fixing portion from the piston side; mounting the flow path, limiting-opening mechanism after inserting the flow path limiting-opening mechanism from the rod guide side; and fixing the annular rod-guide-side fixing member by fitting the annular rod-guide-side fixing member into the groove after inserting the annular rod-guide-side fixing member from the rod guide side.

### BRIEF DESCRIPTION OF THE DRAWINGS

FIG. 1 is a vertical sectional view of a hydraulic shock absorber as a cylinder device according to a first embodiment of the present invention.

FIG. 2 is an enlarged sectional view of a lock piston in FIG. 1.

FIG. 3 is a further enlarged partial sectional view of a fitting cylindrical body, a restriction ring, and a cushioning member in FIG. 2.

FIG. 4 is a vertical sectional view of a hydraulic shock absorber as a cylinder device according to a second embodiment of the present invention.

FIG. 5 is a vertical sectional view of a state in which a lock piston of a locking mechanism is assembled to an outer peripheral side of a piston rod according to a third embodiment of the present invention.

FIG. 6 is a perspective view of only a restriction-ring integrated type cushioning member in FIG. 5.

FIG. 7 is a perspective view of a state in which the restriction-ring integrated type cushioning member in FIG. 6 is inverted upside down.

FIG. 8 is a plan view of the restriction-ring integrated type cushioning member illustrated in FIG. 6.

FIG. 9 is a sectional view of the restriction-ring integrated type cushioning member as viewed in a direction of the arrows IX-IX in FIG. 8.

FIG. 10 is a bottom view of the restriction-ring integrated type cushioning member illustrated in FIG. 6.

### DETAILED DESCRIPTION OF THE PREFERRED EMBODIMENTS

Now, with reference to the accompanying drawings, detailed description is made of a cylinder device and a manufacturing method therefore according to embodiments of the present invention by way of an example in which the cylinder device and the manufacturing method therefore are applied to a hydraulic shock absorber.

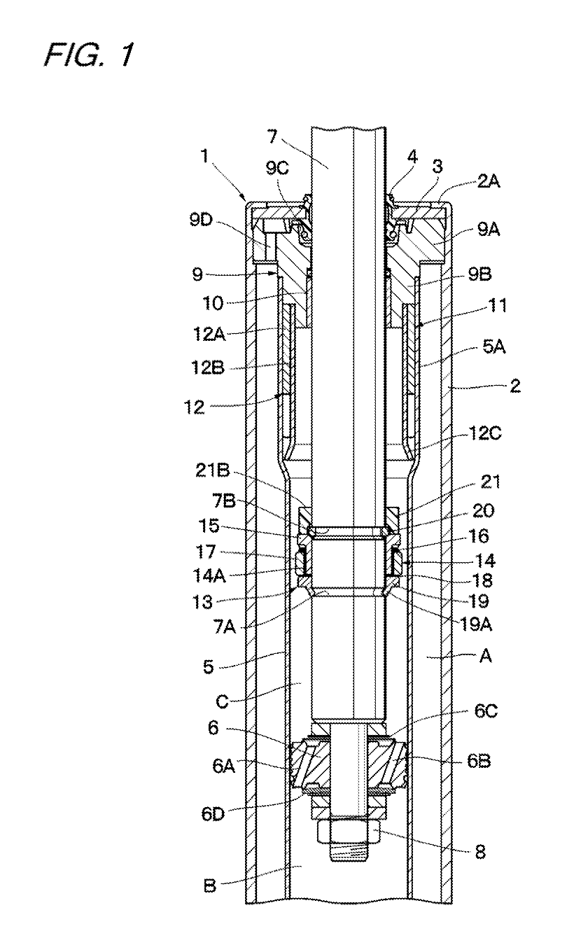

Specifically, FIGS. 1 to 3 illustrate a first embodiment of the present invention. FIG. 1 illustrates a hydraulic shock absorber 1 as a typical example of cylinder devices. The hydraulic shock absorber 1 includes an outer cylinder 2 as an outer shell thereof, an inner cylinder 5, a piston 6, a piston rod 7, a rod guide 9, and a locking mechanism 11, which are described below.

One end (lower end in FIG. 1) side of the outer cylinder 2 of the hydraulic shock absorber 1 is a closed end closed by a bottom cap (not shown), and an upper end side as another end side thereof is an open end. On the open end (upper end) side of the outer cylinder 2, there is provided a crimped portion 2A formed by bending the upper end to a radially inner side, and the crimped portion 2A retains a lid member 3 for closing the open end side of the outer cylinder 2.

In order to close the open end (upper end) side of the outer cylinder 2, the lid member 3 is formed of an annular disk, and an outer peripheral side thereof is fixed in abutment against the rod guide 9 described below by the crimped portion 2A of the outer cylinder 2. On an inner peripheral side of the lid member 3, a rod seal 4 made of an elastic material is mounted, and the rod seal 4 seals between the piston rod 7 described below and the lid member 3.

The inner cylinder 5 as a cylinder is provided coaxially with the outer cylinder 2, and one end (lower end) side or the inner cylinder 5 is fitted and fixed to the bottom cap side through intermediation of a bottom valve (not shown). On another end (upper end) side of the inner cylinder 5, a cylindrical large diameter portion 5A is formed by being expanded radially outward, and the rod guide 9 described below is fitted and recanted to an inner periphery on the upper end side of the large diameter portion 5A. Oil liquid as working fluid is sealed in the inner cylinder 5. The working fluid is not limited to the oil liquid and other oils, and water mixed with additives and the like may be used, for example.

An annular reservoir chamber A is formed between the inner cylinder 5 and the enter cylinder 2. In this reservoir chamber A, gas is sealed together with the oil liquid. Examples of the gas may include air at atmospheric pressure and gases such as a compressed nitrogen gas. The gas in the reservoir chamber A is compressed to compensate a volume corresponding no an amount of entry of the piston rod 7 at the time of compression (compression stroke) of the piston rod 7.

The piston 6 is fit-inserted to be slidable in the inner cylinder 5. The piston 6 divides an inside of the inner cylinder 5 (cylinder) into a bottom side oil chamber B and a rod side oil chamber C. Further, through the piston 6, there are formed oil paths 6A and 6B capable of communicating the bottom side oil chamber B and the rod side oil chamber C to each other. Further, on an upper end surface of the piston 6, there is arranged a compression side disk valve 6C for applying a resistance force to the oil liquid flowing through the oil path 6A so as to generate a predetermined damping force in conjunction with downward sliding displacement of the piston 6 along with the compression of the piston rod 7. Meanwhile, on a lower end surface of the piston 6, there is arranged an extension side disk valve 6D for applying a resistance force to the oil liquid flowing through the oil path 6B so as to generate a predetermined damping force in conjunction with upward sliding displacement of the piston 6 along with extension of the piston rod 7.

One end (lower end) side of the piston rod 7 is coupled to the piston 6. Specifically, the lower end side of the piston rod 7 is inserted into the inner cylinder 5, and fixed to an inner peripheral side of the piston 6 with a nut 8 and the like. Further, an upper end side of the piston rod 7 is projected to be stretchable to an outside through the rod guide 9, the lid member 3, and other components. The piston rod 7 includes first and second annular grooves 7A and 7B provided at respective positions spaced apart by predetermined dimensions with respect to a mounting portion of the piston 6. An annular stopper 19 described below is fitted and fixed to the first annular groove 7A, and a restriction ring 20 described below is mounted to the second annular groove 7B.

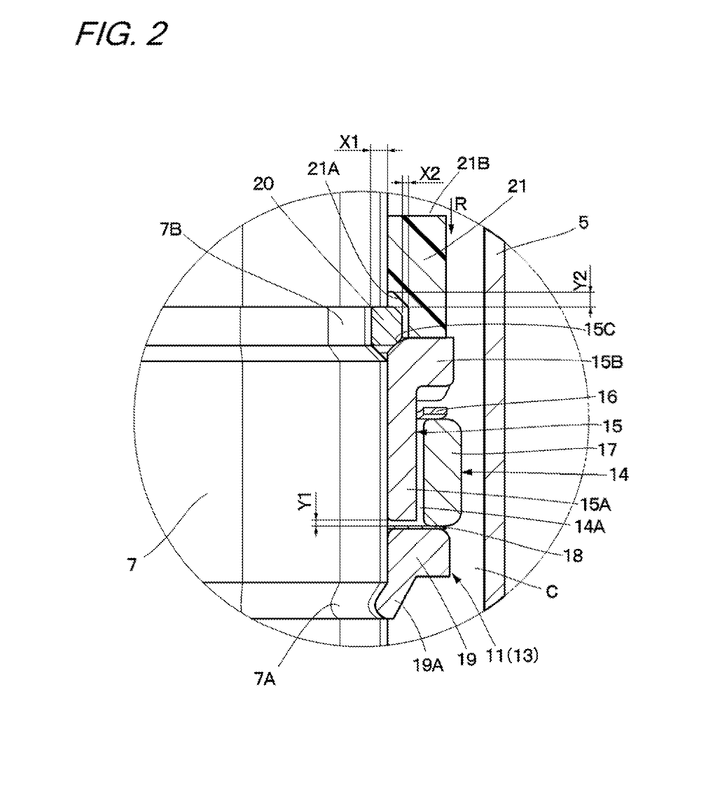

Note that, the first and second annular grooves 7A and 7B extend around the entire outer peripheral side of the piston rod 7, and are arranged at a predetermined interval in an axial direction of the piston rod 7. As illustrated in FIG. 2, the second annular groove 7B is formed to have a groove depth of a dimension X1. The dimension X1 in this case is set to satisfy the relationship of Expression 1. below with respect to a dimension X2 described below.

The rod guide 9 is formed into a stepped cylindrical shape, and not only fitted to the upper end side of the outer cylinder 2 but also fixed to the upper end side of the large diameter portion 5A of the inner cylinder 5. With this, the rod guide 9 causes an upper part of the inner cylinder 5 to be positioned to a center of the outer cylinder 2, and guides, on an inner peripheral side thereof, the piston rod 7 in a slidable manner in the axial direction. Further, the rod guide 9 serves as a support structure for supporting the lid member 3 from an inside thereof at the time of fixation of the lid member 3 from the outside with the crimped portion 2A of the outer cylinder 2.

The rod guide 9 is obtained by forming a metal material, a hard resin material, and the like into a predetermined shape by a molding process, a trimming process, and the like. Specifically, as illustrated in FIG. 1, the rod guide 9 is formed into the stepped cylindrical shape including a large diameter portion 9A positioned on an upper side and fit-inserted to an inner peripheral side of the outer cylinder 2, and a small diameter portion 9B positioned on the lower side of the large diameter portion 9A and fit-inserted to an inner peripheral side of the inner cylinder 5. On an inner peripheral side of the small diameter portion 9B, there is provided a guide portion 10 for guiding the piston rod 7 in a slidable manner in the axial direction. The guide portion 10 is formed of a slidable cylindrical body obtained by covering, for example, an inner peripheral surface of a metal cylindrical body with a fluororesin (polytetrafluoroethylene) and the like.

Further, in the large diameter portion 9A of the rod guide 9, an annular oil pool chamber 9C is provided on an upper surface side of the large diameter portion Sea. facing the lid member 3, and the oil pool chamber 9C is formed as an annular space portion surrounding the rod seal 4 and the piston red 7 from a radially cuter side. In addition, the oil pool chamber 9C serves as a space for temporarily pooling, for example, the oil liquid (or gas that is mixed in this oil liquid) in the rod side oil chamber C, which may leak out, for example, through small gaps between the piston rod 7 and the guide portion 10.

Further, through the large diameter portion 9A of the rod guide 9, there is provided a communication path 9D communicating constantly to the reservoir chamber A on the outer cylinder 2 side, and the communication, path 9D guides the oil liquid (containing gas) pooled in the oil pool chamber 9C to the reservoir chamber A on the outer cylinder 2 side. Note that, a check valve (not shown) is interposed between the lid member 3 and the rod guide 9. Specifically, the check valve interposed between the lid member 3 and the rod guide 9 allows the leakage oil in the oil pool chamber 9C, which may increase in amount and overflow therefrom, to flow to the communication path 9D (reservoir chamber A) side of the rod guide 9, and prevents reverse flow of the leakage oil.

Next, detailed description is made of the locking mechanism 11 of a hydraulic type, which is employed in the first embodiment, When the piston rod 7 extends outward from the outer cylinder 2 and the inner cylinder 5 and reaches a full extension position, the locking mechanism 11 is actuated as described below so as to generate a hydraulic cushioning effect for stopping extension movement of the piston rod 7. In this way, what is called full extension is prevented.

The locking mechanism 11 includes a lock cylinder portion 12 fixed to an inside of the large diameter portion 5A while being positioned in the inner cylinder 5 on the projecting side of the piston rod 7, and a lock piston 13 provided on the outer peripheral side of the piston rod 7 while being positioned on the rod guide 9 side with respect to the piston 6. At maximum extension of the piston red 7, the lock piston 13 is fit-inserted (moved-in) to be slidable on an inner peripheral side of the lock cylinder portion 12.

The lock cylinder portion 12 includes a sleeve 12B retained through intermediation of a cylindrical collar 12A in the large diameter portion 5A of the inner cylinder 5. An upper end side of the sleeve 12B is fitted and fixed to a lower end side of the small diameter portion 9B of the rod guide 9. On a lower end side of the sleeve 12B, an open, end 12C is expanded into a tapered shape. The open end 12C facilitates and compensates fit-insertion of the lock piston 13, which moves integrally with the piston rod 7, to be slidable into the sleeve 12B.

The look piston 13 serves as a movable unit of the locking mechanism 11. The lock piston 13 is provided on the outer peripheral side of the piston rod 7, and includes a flow path limiting-opening mechanism 14 for limiting a flow path 14A when the lock piston 13 moves upward into the lock cylinder portion 12 (sleeve 12B) and for opening the flow path 14A when the lock piston 13 moves downward out of the look cylinder portion 12, and includes the annular stopper 19 and the restriction ring 20 described below.

As illustrated in FIG. 2, the flow path limiting-opening mechanism 14 of the lock piston 13 includes a fitting cylindrical body 15, an annular plate spring 16, a movable cylinder 17, and an annular plate 18 that are provided to be displaceable relative to the outer peripheral side of the piston rod 7. The flow path 14A of the flow path limiting-opening mechanism 14 is formed as an oil path between the fitting cylindrical body 15 and the movable cylinder 17 and between the movable cylinder 17 and the annular plate 18. The annular plate 18 serves as what is called a disk valve, and includes slits (not shown) for causing drawing action to the oil liquid flowing through the flow path 14A on an outer peripheral side of the annular plate 18.

As illustrated in FIG. 2, the fitting cylindrical body 15 of the flow path limiting-opening mechanism 14 includes a cylindrical portion 15A fit-inserted to be slidable on the outer peripheral aide of the piston rod 7 at a position between the annular stopper 19 and the restriction ring 20, an annular flange portion 15B integrally formed to project radially outward from an tipper end (another end) side of the cylindrical portion 15A, and a circular-arc chamfered portion 15C formed to abut against the restriction ring 20 at a position between the cylindrical portion 15A and the flange portion 15B.

The movable cylinder 17 of the flow path limiting-opening mechanism 14 is formed of a cylindrical body loosely fitted to be displaceable relative to an outer peripheral side of the cylindrical portion 15A. An axial dimension of the movable cylinder 17 is set to be smaller than an axial dimension of the cylindrical portion 15A of the fitting cylindrical body 15, and an outer diameter dimension of the movable cylinder 17 is set to be larger than an outer diameter dimension of the flange portion 15B of the fitting cylindrical body 15.

Thus, when the lock piston 13 is fit-inserted to foe slidable into the lock cylinder portion 12 (that is, when the movable cylinder 17 moves into the sleeve 12B), an outer peripheral surface of the movable cylinder 17 is brought into sliding contact with an inner peripheral surface of the sleeve 12B. Meanwhile, none of outer peripheral surfaces of the flange portion 15B and the annular stopper 19 is brought into contact with the inner peripheral surface of the sleeve 12B. At this time, the movable cylinder 17 is relatively displaced in the axial direction on the outer peripheral side of the fitting cylindrical body 15 (cylindrical portion 15A) so as to cause variation (in flow path area) for shrinking or expanding the flow path 14A between the fitting cylindrical body 15 and the movable cylinder 17.

The annular plate spring 16 is formed of a spring member such as a corrugated washer, and sandwiched between the flange portion 15B of the fitting cylindrical body 15 and the movable cylinder 17. With this, the annular plate spring 16 urges the flange portion 15B of the fitting cylindrical body 15 and the movable cylinder 17 to be spaced apart from each other in the axial direction (upward and downward), and causes the annular plate 18 to be sandwiched between a lower end side of the movable cylinder 17 and the annular stopper 19. Further, the flange portion 15B of the fitting cylindrical body 15 is held in abutment against from below a cushioning member 21 described below, and the chamfered portion 15C is held in abutment against the restriction ring 20.

In this state, as illustrated in FIG. 2, an axial gap Y1 is formed between a lower end of the cylindrical portion 15A and the annular plate 18, and a dimension of the axial gap Y1 is set to be smaller than a dimension of another axial gap 112 as expressed by Expression 2 below. Thus, a rebound input described below (force in a direction of the arrow R in FIG. 2, hereinafter referred to as rebound input R) is received on the annular stopper 19 side when the lower end of the cylindrical portion 15A of the fitting cylindrical body 15 is brought into abutment against the annular plate 18. As a result, the rebound input R can be prevented from being applied to the restriction ring 20.

The annular stopper 19 serves as a piston-side fixing portion for supporting the annular plate 18 of the flow path limiting-opening mechanism 14 from the piston 6 side. Prior to assembly of the piston 6 to the one end (lower end) side of the piston rod 7, the annular stopper 19 is inserted from the one end side (lower side) thereof along the outer peripheral side of the piston rod 7, and fitted and fixed into the first annular groove 7A with a jig for performing metal flow (plastic flow). The annular stopper 19 is formed of an annular body made of a metal material, and includes a fitting portion 19A to be fitted and retained in the first annular groove 7A through the metal flow.

Another side (upper) surface of the annular stopper 19 serves as a fiat support surface for supporting the annular plate 18 as the disk valve from below. The annular plate spring 16 presses one side (lower) surface of the movable cylinder 17 against the annular plate 18 so as to hold and sandwich the annular plate 18 between the movable cylinder 17 and the annular stopper 19. However, when the piston rod 7 starts to reversely move in a compression direction from the maximum extension position (that is, when the lock piston 13 moves downward out of the lock cylinder portion 12), the movable cylinder 17 is relatively displaced upward against the annular plate spring 16. With this, the annular plate 18 is displaced in a valve opening direction between the movable cylinder 17 and the annular stopper 19 so as to open the flow path 14A.

The restriction ring 20 serves as an annular rod-guide-side fixing member for restricting the fitting cylindrical body 15 of the flow path limiting-opening mechanism 14 from moving to the rod guide 9 side. The restriction ring 20 is formed as a radially shrinkable and expandable ring made of an elastic material softer than an outer peripheral surface of the piston rod 7 (for example, synthetic resin such as nylon, or soft metal).

Specifically, the restriction ring 20 is formed, for example, of a C-shaped ring that is partially cert at a halfway part (one point) in a circumferential direction so as to be radially shrinkable and expandable. Under a free state (free length state), the restriction ring 20 is elastically shrunk in a radial direction so that an inner diameter dimension thereof is equal to or smaller than a radial dimension of the second annular groove 7B. Meanwhile, when an external force is applied to elastically deform the restriction ring 20 so that the restriction ring 20 is radially expanded, the inner diameter dimension thereof is larger than an outer diameter dimension of the rod guide 9. Thus, even when the restriction ring 20 is inserted along the outer peripheral surface of the piston red 7, the restriction, ring 20 does not damage the outer peripheral, surface of the piston rod 7.

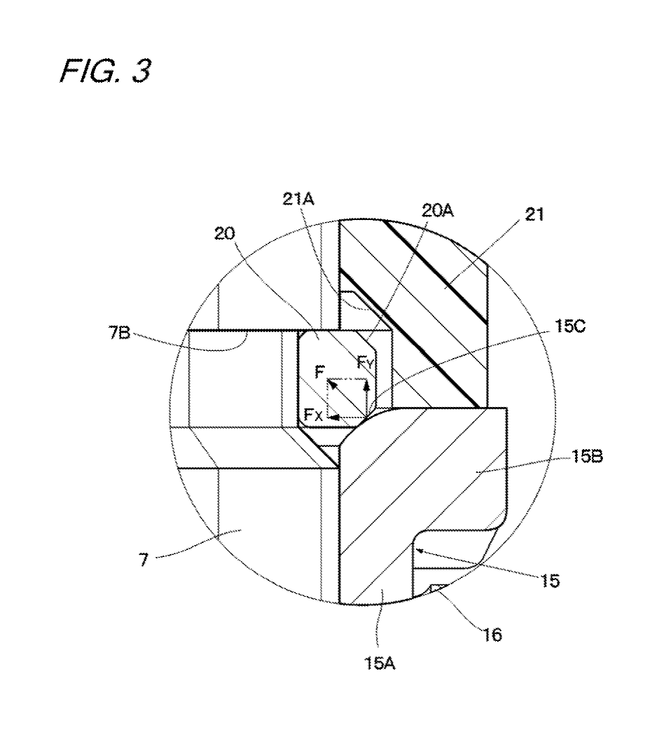

Further, as illustrated in FIG. 3, the restriction ring 20 is formed as a ring having a quadrangular shape in horizontal cross-section, and inclined chamfers 20A are formed at four corner sides thereof. Note that, in a case where the restriction ring 20 as the rod-guide-side fixing member is made of a metal material, it is appropriate to form a protective film made of a fluororesin such as PTFE or a rubber elastic material on an inner peripheral surface of the restriction ring 20 (that is, surface no be held in sliding contact with the outer peripheral surface of the piston rod 7).

In addition, the restriction ring 20 is inserted along the outer peripheral surface of the piston rod 7 from another end (upper end) side of the piston rod 7, that is, the rod guide 9 side after the components (fitting cylindrical body 15, annular plate spring 16, movable cylinder 17, and annular plate 18) of the flow path limiting-opening mechanism 14 are mounted to the outer peripheral side of the piston rod 7. Lastly, the restriction ring 20 is fixed by being fitted into the second annular groove 7B by an elastic restoring force (radially shrinking force) of the restriction ring 20 itself.

As illustrated in FIG. 3, under a state in which the restriction ring 20 is fitted in the second annular groove 7B, an outer peripheral side of a lower end of the restriction ring 20 is held in abutment against the chamfered portion 15C of the fitting cylindrical body 15, and receives a load F generated by an urging force applied from the annular plate spring 16 to the fitting cylindrical body 15 (force in a direction perpendicular to the chamfered portion 15C). This load F is decomposed into a radially inward component force Fx and an axial component force Fy with respect to the restriction ring 20. Of those, the radially inward component force Fx is applied to press the restriction ring 20 into the second annular groove 7B so that a force of preventing the restriction ring 20 from dropping from the second annular groove 7B (pressing force in a retaining direction) is generated.

Further, the axial component force Fy generates a shearing force to the restriction ring 20 fitted in the second annular groove 7B. However, this component force Fy is less than the load F in the direction perpendicular to the chamfered portion 15C, and hence the shearing force can be prevented. Specifically, the chamfered portion 15C of the fitting cylindrical body 15 is formed into an inclined circular-arc surface, and hence the shearing force to be applied to the restriction ring 20 fitted in the second annular groove 7B can be reduced. As a result, the restriction ring 20 can be enhanced in durability and a life thereof can be prolonged.

The cushioning member 21 is an anti-collision buffer member provided by being inserted along the outer peripheral side of the piston rod 7, and serves as a stopper for moderating impact on the rod guide 9. The cushioning member 21 is obtained by forming an elastically deformable resin or a rubber material (for example, an elastic material softer than the restriction ring 20) into a stepped cylindrical body.

Along an inner periphery on one side (lower end side) of the cushioning member 21, an annular recessed portion 21A is formed out of contact with the restriction ring 20. As illustrated in FIG. 2, a radial gap X2 is formed between the recessed portion 21A of the cushioning member 21 and an outer periphery of the restriction ring 20. An axial gap Y2 is formed between an upper surface (another side surface) of the restriction ring 20 and the recessed portion 21A of the cushioning member 21.

Note that, the radial gap X2 is set to be smaller than the groove depth (dimension X1) of the second annular groove 7B, that is, to satisfy the relationship expressed by Expression 1 below. The axial gap Y2 is set to be larger than the gap Y1 between the lower end of the cylindrical portion 15A and the annular plate 18, that is, to satisfy the relationship expressed by Expression 2 below.

X1>X2 (Expression 1)

Y1<Y2 (Expression 2)

When the relationship expressed by Expression 1 is satisfied, the recessed portion 21A of the cushioning member 21 prevents the restriction ring 20 from being displaced and disengaged radially outward from the second annular groove 7B so as to prevent the restriction ring 20 from dropping. Further, even in a case where the rebound input R (refer to FIG. 2) occurs to the cushioning member 21, when the relationship expressed by Expression 2 is satisfied, this rebound input R can be prevented from being applied to the restriction ring 20. In other words, the rebound input R from the cushioning member 21 is received on the annular plate 18 side and on the annular stopper 19 side from the lower end Of the cylindrical portion 15A through intermediation of the fitting cylindrical body 15. Thus, the rebound input R is not applied to the restriction ring 20.

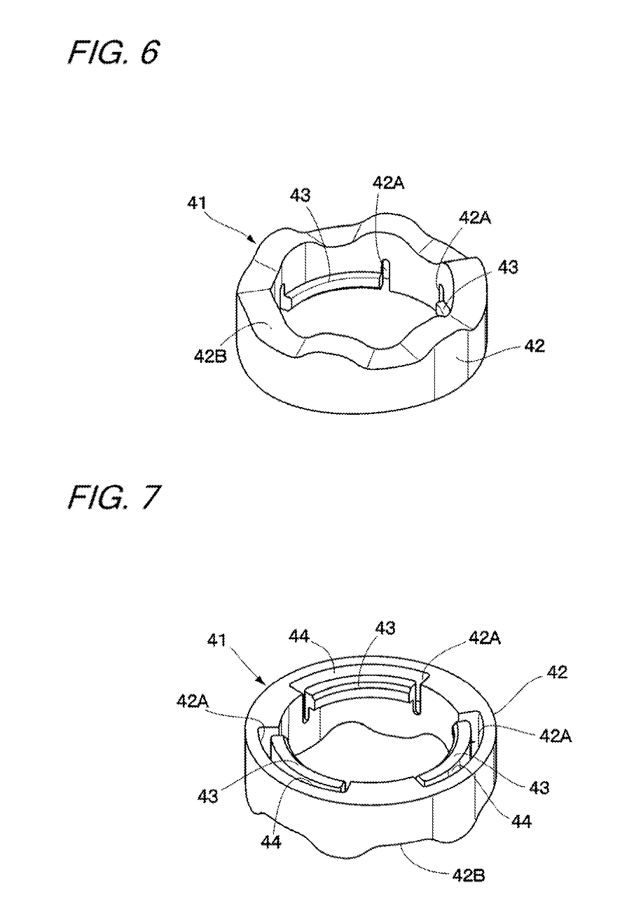

Similarly to an upper surface 42B of a cushioning portion 42 illustrated in FIG. 6 described below, another side surface 21B of the cushioning member 21 (hereinafter referred to as upper surface 21B) is formed into a corrugated uneven surface. Thus, at maximum extension of the piston rod 7, even when the cushioning member 21 moves into the lock cylinder portion 12 together with the lock piston 13, and the upper surface 21B of the cushioning member 21 abuts against a lower surface of the rod guide 9 (small diameter portion 9B), the corrugated uneven surface (upper surface 21B of the cushioning member 21) prevents occurrence of a phenomenon of close contact therebetween or the like.

The structure of the hydraulic shock absorber 1 as the cylinder device according to the first embodiment is described above. Next, description is made of a manufacturing method for the cylinder device.

In order to assemble the lock piston 13 serving as a movable unit of the hydraulic locking mechanism 11 to the piston rod 7, a fixing step for the piston-side fixing portion is performed prior to the mounting of the piston 6 to the piston rod 7. Specifically, the fixing step for the piston-side fixing portion includes inserting the annular stopper 19 as the piston-side fixing portion along the outer peripheral surface of the piston rod 7 from the piston 6 side as the one side (lower end side) of the piston rod 7, and fitting the fitting portion 19A into the first annular groove 7A with fixing means such as the metal flow, to thereby fix the annular stopper 19 to the piston rod 7.

Next, a mounting step tor the flow path limiting-opening mechanism 14 is performed The mounting step includes inserting and mounting the components (specifically, annular plate 18, movable cylinder 17, annular plate spring 16, and fitting cylindrical body 15) of the flow path limiting-opening mechanism 14 along the outer peripheral side of the piston rod 7 from the rod guide 9 side as the another aide (upper end side) of the piston rod 7. In this case, inner diameter dimensions of the annular plate 18, the movable cylinder 17, the annular plate spring 16, and the fitting cylindrical body 15 are each set to be larger than an outer diameter dimension of the piston rod 7. Thus, the components of the flow path limiting-opening mechanism 14 do not damage the outer peripheral surface of the piston rod 7.

Next, a fixing step for the rod-guide-side fixing member is performed. The fixing step includes inserting the restriction ring 20 as the rod-guide-side fixing member along the outer peripheral surface of the piston rod 7 from the rod guide 9 side, and fitting the restriction ring 20 into the second annular groove 7B. After that, the cushioning member 21 is inserted along the outer peripheral side of the piston rod 7, and loosely fitted to the restriction ring 20 from thereabove. At this time, a lower end surface of the cushioning member 21 is brought into abutment against an upper surface of the flange portion 15B of the fitting cylindrical body 15.

Meanwhile, the lock cylinder portion 12 of the locking mechanism 11 is assembled by fitting, through intermediation of the cylindrical collar 12A, the sleeve 12B to an inside of the large diameter portion 5A positioned on the projecting end side of the piston rod 7 in the inner cylinder 5. In this state, the piston rod 7 is inserted through the inside of the inner cylinder 5, and at this time, the piston 6 is fit-inserted to be slidable in the inner cylinder 5.

After that, the large diameter portion 9A and the small diameter portion 9B of the rod guide 9 are press-fitted respectively to the outer cylinder 2 and the inner cylinder 5. Then, the lid member 3 having the rod seal 4 and other components mounted thereon is arranged on an upper side of the rod guide 9. Next, in order to prevent backlash in the axial direction of the rod guide 9, the rod guide 9 is pressed against the inner cylinder 5 through intermediation of the lid member 3, for example, with a cylindrical presser (not shown). In this state, an upper end portion of the outer cylinder 2 is bent to the radially inner side so that a radially outer side of the lid member 3 and the large diameter portion 9A of the rod guide 9 are fixed with the crimped portion 2A.

After that, in the hydraulic shock absorber 1 assembled in this way, the upper end side of the piston rod 7 is mounted to a vehicle body side of an automobile (not shown), and a lower end side of the outer cylinder 2 is mounted to an axle side (not shown). With this, in a case where vibration occurs daring traveling of the automobile, in conjunction with compression and extension, in the axial direction of the piston rod 7 with respect to the inner cylinder 5 and the outer cylinder 2, damping forces are generated en the compression side and the extension side by the disk valves 6C and 6D of the piston 6 and the like. As a result, upward and downward vibration of the vehicle can be damped and buffered.

Specifically, during an extension stroke of the piston rod 7, pressure in the rod side oil chamber C becomes higher. Thus, pressure oil in the rod side oil chamber C flows into the bottom side oil chamber B through the disk valve 6D, and the damping force on the extension side is generated. Then, by an amount corresponding to a moving-out volume of the piston rod 7 with respect to the inner cylinder 5, oil liquid in the reservoir chamber A flows into the bottom side oil chamber E through intermediation of a bottom valve (not shown).

At this time, the pressure in the rod side oil chamber C becomes higher, and hence the oil liquid in the rod side oil chamber C may leak out into the oil pool chamber 9C, for example, through the small gaps between the piston rod 7 and the guide portion 10. Further, when the leakage oil in the oil pool chamber 9C increases in amount and overflows therefrom, the oil is guided to the communication path 9D side of the rod guide 9 through the check valve (not shown) interposed between the lid member 3 and the rod guide 9, and gradually refluxed into the reservoir chamber A.

Meanwhile, during a compression stroke of the piston rod 7, pressure in the bottom side oil chamber B located below the piston 6 becomes higher. Thus, pressure oil in the bottom side oil chamber 8 flows into the rod side oil chamber C through the disk valve 6C of the piston 6, and the damping force on the compression side is generated. Then, by an amount corresponding to a moving in volume of the piston rod 7 into the inner cylinder 5, oil liquid, in the bottom side oil chamber B flows into the reservoir chamber A through intermediation of the bottom valve. In this way, gas in the reservoir chamber A is compressed to absorb the amount of the oil liquid corresponding to the moving-in volume of the piston rod 7.

By the way, in a case where the piston rod 7 largely extends to the outside of the outer cylinder 2, the lock piston 13 as the movable unit of the locking mechanism 11 is fit-inserted (moved-in) to be slidable into the inner peripheral side of the lock cylinder portion 12. At this time, the outer peripheral surface of the movable cylinder 17 of the flow path limiting-opening mechanism 14 of the lock piston 13 is held in sliding contact with the inner peripheral surface of the sleeve 12B. With this, on the outer peripheral side of the fitting cylindrical body 15 (cylindrical portion 15A), the movable cylinder 17 is pressed against the annular plate 18 side and relatively displaced in the axial direction.

Thus, a flow path area of the flow path 14A between the fitting cylindrical body 15 and the movable cylinder 17 is reduced by the slits (not shown) of the annular plate 18 serving as what is called a disk valve, and the oil liquid to flow in the flow path 14A is limited in flow rate. With this, the hydraulic cushioning effect is caused on the displacement in an extending direction of the piston rod 7. As a result, the full extension of the piston rod 7 can be prevented.

Further, even in a case where the piston rod 7 is subjected to the maximum extension up to a position at which the cushioning member 21 collides against the lower surface of the rod guide 9 in the lock cylinder portion 12, the anti-collision cushioning member 21 is elastically deformed at this time to moderate impact. With this, further extension movement of the piston rod 7 can be prevented.

At this time, even in a case where the collision of the cushioning member 21 against the lower surface of the rod guide 9 (email diameter portion 9B) causes the rebound input R (refer to FIG. 2) to the cushioning member 21, the rebound, input R is received on the annular plate 18 side and on the annular stopper 19 side from the lower end of the cylindrical portion 15A through intermediation of the fitting cylindrical body 15. This is because the relationship expressed by Expression 2 is satisfied. Thus, the cushioning member 21 can prevent application of the rebound input R to the restriction ring 20.

Meanwhile, when the piston rod 7 at the maximum extension, is switched to the compression stroke (in other words, when the lock piston 13 moves downward out of the lock cylinder portion 12), the movable cylinder 17 held in sliding contact with the sleeve 12B of the lock cylinder portion 12 is actuated and relatively displaced upward against the annular plate spring 16.

With this, the movable cylinder 17 is spaced, apart upward from the annular plate 18, and the annular plate 18 can be displaced in the valve opening direction between the movable cylinder 17 and the annular stopper 19 so as to open the above-mentioned flow path 14A. As a result, the loch piston 13 is actuated to smoothly move downward out of an inside of the look cylinder portion 12, and smooth compression movement of the piston rod 7 can be compensated.

In this way, according to the first embodiment, the hydraulic locking mechanism 11 includes the lock cylinder portion 12 fixed to the inside of one large diameter portion 5A of the inner cylinder 5 and the lock piston 13 provided on the outer peripheral side of the piston rod 7. The lock piston 13 includes the flow path limiting-opening mechanism 14 provided on the outer peripheral side of the piston rod 7, the annular stopper 19 for supporting the flow path limiting-opening mechanism 14 from the piston 6 side, and the restriction ring 20 for restricting the fitting cylindrical body 15 of the flow path limiting-opening mechanism 14 from moving to the rod guide 9 side, the restriction ring 20 being fitted in the second annular groove 78 of the piston rod 7.

Note that, the restriction ring 20 is formed as a radially shrinkable and expandable ring made of a material softer than the outer peripheral surface of the piston, rod 7 (for example, synthetic resin such as nylon, or soft metal). Thus, at the time of assembly work of inserting the restriction ring 20 along the outer peripheral side of the piston rod 7 from the upper end side of the piston rod 7 (that is, rod guide 9 side), and fitting and fixing the restriction ring 20 into the second annular groove 7B after the components (fitting cylindrical body 15, annular plate spring 16, movable cylinder 17, and annular plate 18) of the flow path limiting-opening mechanism 14 are mounted to the outer peripheral side of the piston rod 7, the outer peripheral surface of the piston rod 7 can be protected from the restriction ring 20.

In other words, at the time of assembling the restriction ring 20, which is made of the soft material, into the second annular groove 7B of the piston rod 7, the restriction ring 20 can be moved in the axial direction along the outer peripheral surface of the piston rod 7, and then fitted and assembled into the second annular groove 7B. With this, scratch marks and the like can be prevented from, being formed on the outer peripheral surface of the piston rod 7 by the restriction ring 20.

Further, in the fitting cylindrical body 15 of the flow path limiting-opening mechanism 14, the inclined circular-arc chamfered portion 15C is provided between the cylindrical portion 15A and the flange portion 15B. As illustrated in FIG. 3, the outer peripheral side of the lower end of the restriction ring 20 under a state of being fitted in the second annular groove 7B is obliquely brought into abutment against the chamfered portion 15C. With this configuration, the urging force applied from the annular plate spring 16 to the fitting cylindrical body 15 is applied as the oblique load F from the chamfered portion 15C of the fitting cylindrical body 15 to the restriction ring 20.

This load F is decomposed, into the radially inward component force Fx and the axial component force Fy with respect to the restriction ring 20. Of those, the radially inward component force Fx enables the restriction ring 20 to be pressed into the second annular groove 7B, to thereby generate the force of preventing the restriction ring 20 from dropping from the second annular groove 7B (pressing force in the retaining direction). Further, the axial component force Fy is less than the load F in the direction perpendicular to the chamfered portion 15C, and the shearing force to be applied to the restriction ring 20 fitted in the second annular groove 7B (that is, shearing force to be applied to the restriction ring 20 by the urging force from the annular plate spring 16) can be prevented. As a result, the restriction ring 20 can be enhanced in durability and the life thereof can be prolonged.

Further, the annular recessed portion 21A is provided on an inner peripheral side of the lower end of the cushioning member 21, and the radial gap X2 and the axial gap Y2 that are formed between the restriction ring 20 and the recessed portion 21A are set to satisfy the relationships expressed by Expressions 1 and 2. Thus, the restriction ring 20 can be prevented from being displaced and disengaged radially outward from the second annular groove 7B, and hence the restriction ring 20 can be prevented from dropping. Further, even in the case where the rebound input R occurs to the cushioning member 21, the rebound input R can be prevented from being applied to the restriction ring 20. This is because the relationship expressed by Expression 2 is satisfied. Also with this, the restriction ring 20 can be enhanced in durability and the life thereof can be prolonged.

In this way, according to the first embodiment, the restriction ring 20 made of the soft material, which has a low attacking property against the piston rod 7, enables the components (fitting cylindrical body 15, annular plate spring 16, movable cylinder 17, and annular plate 18) of the flow path limiting-opening mechanism 14 to be fixed to the outer peripheral side of the piston rod 7. At this time, when the restriction ring 20 is assembled from the rod guide S side to the piston rod 1, the hydraulic shock absorber 1 can be manufactured (produced) by ordinary steps. Further, components of the locking mechanism 11 can be assembled to the piston rod 7 with higher work efficiency, and formation of scratch marks and the like can be prevented.

Note that, in the case of the example described above in the first embodiment, the restriction ring 20 is formed as a radially shrinkable and expandable ring made of a synthetic resin such as nylon, or a soft metal, but the present invention is not limited thereto. For example, the restriction ring (rod-guide-side fixing member) may be made of rubber elastic materials such as a synthetic rubber and a natural rubber. In this case, the restriction ring (rod-guide-side fixing member) needs not be formed of the C-shaped ring that is partially cut at a halfway part in the circumferential direction.

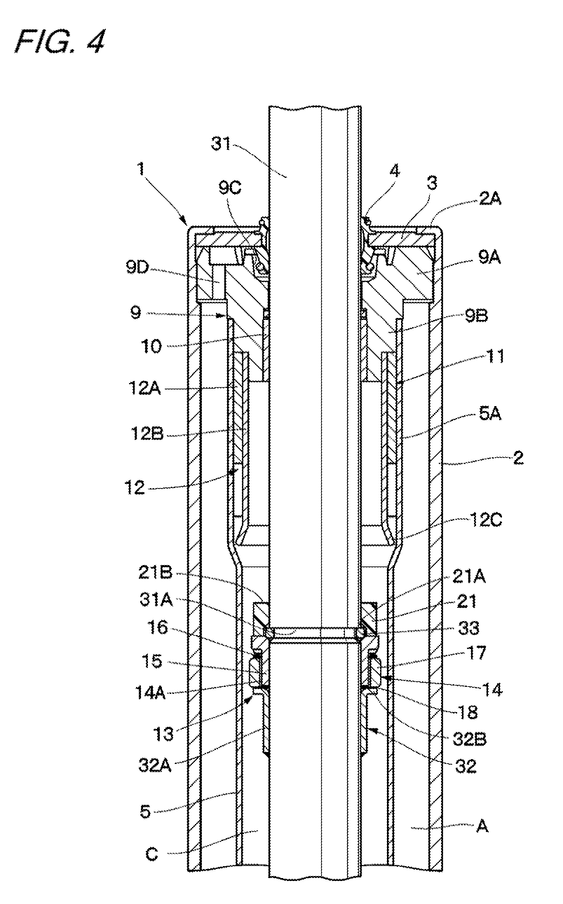

Next, with reference to FIG. 4, description is made of a second embodiment of the present invention. The second embodiment has a feature in that the piston-side fixing portion is fixed to the outer peripheral side of the piston rod by welding means such as spot welding. Note that, in the second embodiment, the same components as those in the first embodiment described above are denoted by the same reference symbols, and description thereof is omitted.

Specifically, a piston rod 31 is configured substantially the same as the piston rod 7 described in the first embodiment, and the piston 6 (refer to FIG. 1) is coupled to a lower end side of the piston rod 31. However, the piston rod 31 in this embodiment includes an annular groove 31A for fixing a restriction ring 33 described below en an outer peripheral side of the piston rod 31, but an annular groove (equivalent to the annular groove 7A in FIG. 1) is not formed at a position of an annular stopper 32.

The annular stopper 32 is used instead of the annular stopper 19 described in the first embodiment, and serves as the piston-side fixing portion for supporting the annular plate 18 of the flow path limiting-opening mechanism 14 from the piston 6 side. However, the annular stopper 32 in this embodiment includes a cylindrical portion 32A to be inserted along the outer peripheral side of the piston rod 31, and an annular flange portion 32B extending radially outward from an upper end side of the cylindrical portion 32A.

Prior to mounting of the piston 6 to one end (lower end) side of the piston rod 31, the annular stopper 32 is inserted along the outer peripheral side of the piston rod 31 from the one end side (lower side). In this state, the cylindrical portion 32A of the annular stopper 32 is fixed to an outer peripheral surface of the piston rod 31 by the welding means such as spot welding.

An upper surface of the annular flange portion 32B of the annular stopper 32 serves as a fiat support surface for supporting the annular plate 18 as the disk valve from below. The annular plate spring 16 presses the one side (lower) surface of the movable cylinder 17 against the annular plate 18 so as to sandwich and hold the annular plate 18 between the annular flange portion 32B of the annular stopper 32 and the lower end surface of the movable cylinder 17.

Similar to the restriction ring 20 described in the first embodiment, the restriction ring 33 serves as the annular rod-guide-side fixing member for restricting the fitting cylindrical body 15 of the flow path limiting-opening mechanism 14 from moving to the rod guide 9 side. However, the restriction ring 33 in this embodiment is formed as a radially shrinkable and expandable ring made of a rubber elastic material, such as a natural rubber and a synthetic rubber. Note that, similar to the restriction ring 20 described in the first embodiment, the restriction ring 33 may be formed as the radially shrinkable and expandable ring made of a synthetic resin such as nylon, or a soft metal.

In this way, also in the second embodiment configured as described above, the restriction ring 33 made of the soft material, which has a low attacking property against the piston rod 31, enables the components (fitting cylindrical body 15, annular plate spring 16, movable cylinder 17, and annular plate 18) of the flow path limiting-opening mechanism 14 to be fixed to the outer peripheral side of the piston rod 31. Thus, the same functions and advantages as those in the first embodiment can be obtained.

Specifically, according to the second embodiment, the annular stopper 32 can be used as the piston-side fixing portion for supporting the annular plate 18 of the flow path limiting-opening mechanism 14 from the piston 6 side, under the state in which the annular stopper 32 is inserted along the outer peripheral side of the piston rod 31 from the one end side flower side), the cylindrical portion 32A of the annular stopper 32 is fixed to the outer peripheral surface or the piston rod 31 by the welding means such as spot welding.

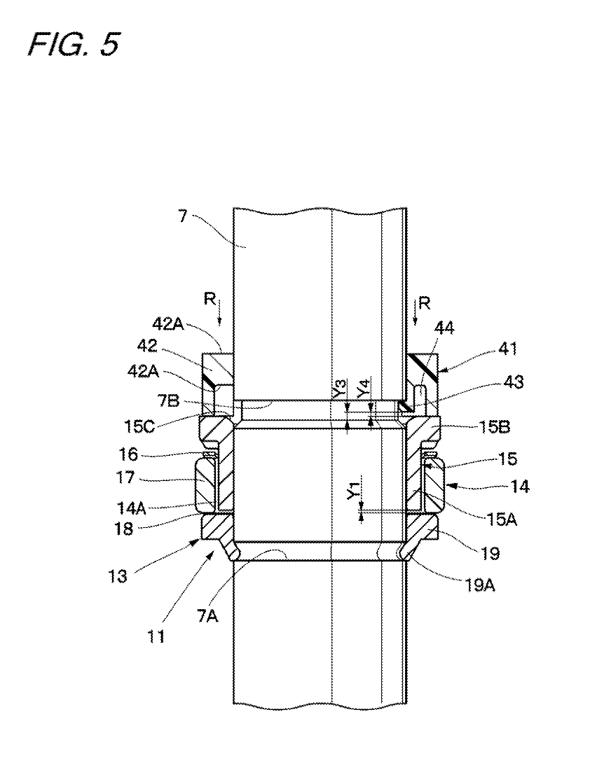

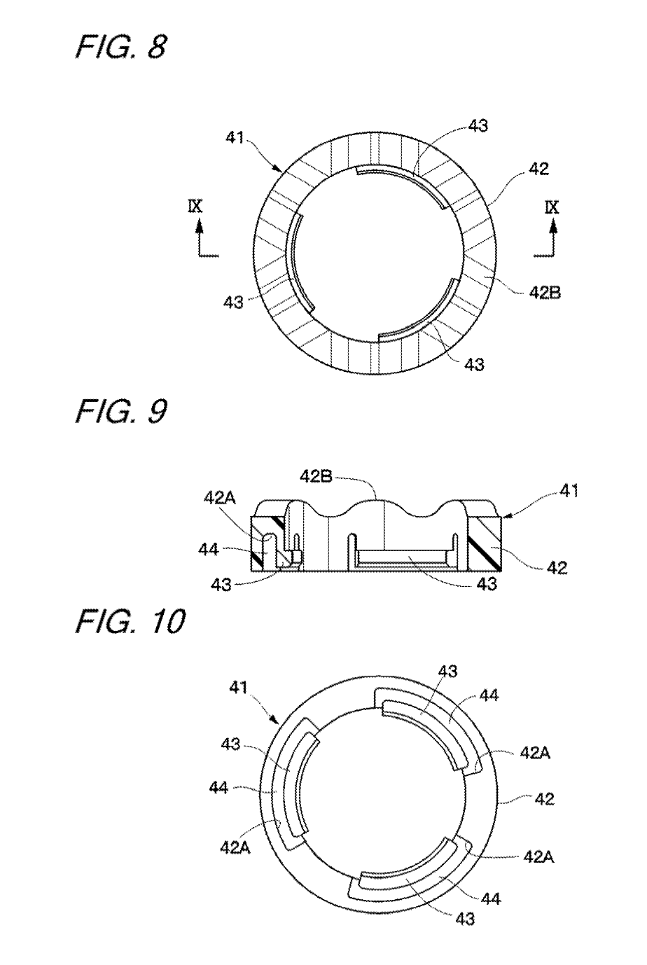

Next, FIGS. 5 to 10 illustrate a third embodiment of the present invention. This embodiment, has a feature in that the rod-guide-side fixing member of the lock piston and the cushioning member are formed integrally with each other into a single component. Note that, in the third embodiment, the same components as those in the first embodiment described above are denoted by the same reference symbols, and description thereof is omitted.

A restriction-ring integrated type cushioning member 41 (hereinafter abbreviated as integrated type cushion 41) is obtained by forming, for example, an elastic resin material into the restriction ring 20 and the cushioning member 21, which are described above in the first embodiment, integrally with each other. The integrated type cushion 41 is inserted along the outer peripheral side of the piston rod 7, and includes the cushioning portion 42 formed into a stepped cylindrical shape as a stopper for moderating impact on the rod guide 9, and a total of three engaging claws 43 provided at intervals on an inner peripheral side of the cushioning portion 42.

The cushioning portion 42 of the integrated type cushion 41 includes a total of three recessed portions 42A at intervals in the circumferential direction on an inner periphery of one side (lower side) of the cushioning portion 42. As illustrated in FIGS. 7 and 10, those recessed portions 42A are each formed into an arcuate shape to extend in the circumferential direction. In addition, respectively in the recessed portions 42A, the engaging claws 43 each similarly formed into an arcuate shape are arranged via circumferential gaps 44. As illustrated in FIG. 6, another side surface 42B (hereinafter referred to as upper surface 42B) of the cushioning portion 42 is formed into a corrugated uneven surface.

Thus, at maximum extension of the piston rod 7, even when the integrated type cushion 41 moves into the lock cylinder portion 12 together with the lock piston 13, and the upper surface 42B of the cushioning portion 42 abuts against the lower surface of the rod guide 9 (small diameter portion 9B), the corrugated uneven surface (upper surface 42B of the cushioning portion 42) prevents occurrence of a phenomenon of close contact therebetween or the like.

The engaging claws 43 of the integrated type cushion 41 are each formed into a claw piece having an L-shape in horizontal cross-section integrally in the recessed portions 42A of the cushioning portion 42. When the integrated type cushion 41 is inserted along the outer peripheral surface of the piston rod 7, the engaging claws 43 are elastically deflected and deformed to the circumferential gap 44 side (radially outer side of the cushioning portion 42), and engaged with the second annular groove 7B when reaching a position of the annular groove 7B (refer to FIG. 5). In other words, the engaging claws 43 of the integrated type cushion 41 are fitted and fixed into the second annular groove 7B by an elastic restoring force (force in a radially shrinking direction) of themselves.

At this time, one side surface (lower surface) of the cushioning portion 42 is brought into abutment against the flange portion 15B of the fitting cylindrical body 15 from thereabove. In this way, the integrated type cushion 41 serves as the annular rod-guide-side fixing member, and restricts the fitting cylindrical body 15 of the flow path limiting-opening mechanism 14 from moving to the rod guide 9 side.

Note that, a dimension Y3 illustrated in FIG. 5 represents a gap between the engaging claws 43 and one second annular groove 7B under the state in which the engaging claws 43 are fitted in the second annular groove 7B, that is, represents a range in which the engaging claws 43 are movable with respect to the second annular groove 7B in the axial direction. A dimension Y4 represents an axial clearance between a lower surface of the cushioning portion 42 and a lower surface of each of the engaging claws 43. Further, as described in the first embodiment, the gap Y1 is formed between the lower end of the fitting cylindrical body 15 (cylindrical portion 15A) and the annular plate 18.

Thus, the dimension Y3 is set to be larger than the gap Y1 so that Expression 3 below is satisfied, and the dimension Y4 is set to zero or a positive value more than zero. With this, even when the rebound input R (refer to FIG. 3) occurs to the integrated type cushion 41, the rebound input R can be prevented from being applied to the engaging claws 43. In other words, the rebound input R from the integrated type cushion 41 is received on the annular plate 18 side and on the annular stopper 19 side from the lower end of the cylindrical portion 15A through intermediation of the fitting cylindrical body 15. Thus, the rebound input R is not applied to the engaging claws 43.

Y1<Y3 (Expression 3)

In this way, also in the third embodiment configured as described above, the restriction-ring integrated type cushioning member 41 (that is, integrated type cushion 41) made of the soft material, which has a low attaching property against the piston rod 7, enables the components (fitting cylindrical body 15, annular plate spring 16, movable cylinder 17, and annular plate 18) of the flow path limiting-opening mechanism 14 to be fixed to the outer peripheral side of the piston rod 7. Thus, the same functions and advantages as those in the first embodiment can be obtained.

Specifically, the integrated type cushion 41 used in the third embodiment is obtained by forming, for example, an elastic resin material into a single component including the restriction ring 20 and the cushioning member 21 that are described above in the first embodiment. Thus, the number of components can be reduced, and work efficiency during assembly can be enhanced, which leads to reduction in manufacturing cost.

Note that, in the case of the example described above in the third embodiment, the total of three engaging claws 43 are provided to the integrated type cushion 41, but the present invention is not limited thereto. For example, one, two, or four or more engaging claws may be provided on the inner peripheral side of the cushioning portion 42. In this case, on the inner periphery of the one side (lower side) of the cushioning portion 42, there may be provided at least one recessed portion extending in the circumferential direction, and at least one engaging claw to be radially shrinkable and expandable may be provided within the at least one recessed portion.

Further, in the embodiments described above, the hydraulic shock absorber 1 to be mounted to each axle side of a four-wheeled automobile is exemplified as a cylinder device, but the present invention is not limited thereto. For example, the cylinder device may include hydraulic shock absorbers for two-wheeled vehicles, or may include cylinder devices to be used not only for automobiles but also for other various machines, constructions, and the like.

Next, description is made of the scope of the embodiments described above. According to one embodiment of the present invention, the stopper (for example, cushioning member 21 illustrated in FIG. 2) for moderating impact on the rod guide is interposed between the loch piston and the rod guide so that the gap is formed in the axial direction between the stopper and the rod-guide-side fixing member.

Further, the rod-guide-side fixing member is made of a nylon material. However, the rod-guide-side fixing member may be formed of a metal member, and a film made of a fluororesin such as PTFE may be formed on the surface to be held in sliding contact with the piston rod. Alternatively, the rod-guide-side fixing member may be formed integrally with the stopper (that is, cushioning member) for moderating the impact on the rod guide.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Applications No. 2013-204055 filed on Sep. 30, 2013. The entire disclosures of No. 2013-204055 filed on Sep. 30, 2013 including specification, claims, drawings and summary are incorporated herein by reference in its entirety.

What is claimed is:

1. A cylinder device, comprising:
a cylinder in which working fluid is sealed;
a piston that is fit-inserted to be slidable in the cylinder and divides an inside of the cylinder;
a piston rod that is coupled to the piston;
a rod guide for guiding the piston rod in a slidable manner by allowing the piston rod to be inserted through the rod guide, the rod guide being mounted to the cylinder; and
a locking mechanism that is actuated when the piston rod extends to reach a full extension position of the cylinder,
wherein the locking mechanism comprises:
a lock piston that is provided on the piston rod on the rod guide side with respect to the piston; and
a lock cylinder portion that is provided in the cylinder on a projecting end side of the piston rod and is provided to allow the lock piston to be slidably inserted through the lock cylinder portion,
wherein the lock piston comprises:
a flow path limiting-opening mechanism for limiting a flow path when the lock piston moves into the lock cylinder portion, and. opening the flow path when, the lock piston moves out of the lock cylinder portion;
a piston-side fixing portion for supporting the flow path limiting-opening mechanism from the piston side, the piston-side fixing portion being provided on an outer peripheral side of the piston rod; and
an annular rod-guide-side fixing member for restricting the flow path limiting-opening mechanism from moving to the rod guide side, the annular rod-guide-side fixing member being fitted in a groove that is formed along the piston rod, and
wherein the annular rod-guide-side fixing member comprises one of a resin and a rubber at least on an inner peripheral side of the annular rod-guide-side fixing member so as to enable the annular rod-guide-side fixing member to be inserted in sliding contact with the piston rod.

2. A cylinder device according to claim 1, wherein the annular rod-guide-side fixing member is made of a nylon material.

3. A cylinder device according to claim 1,
wherein the annular rod-guide-side fixing member comprises a metal member, and
wherein the annular rod-guide-side fixing member is subjected to application of a fluororesin of PTFE on a surface to be held in sliding contact with the piston rod.

4. A cylinder device according to claim 1, further comprising a stopper for moderating impact on the rod guide, the stopper being interposed between the lock piston and the rod guide,
wherein the stopper and the annular rod-guide-side fixing member have a gap formed therebetween in an axial direction.

5. A cylinder device, comprising:
a cylinder in which working fluid is sealed;
a piston that is fit-inserted to be slidable in the cylinder and divides an inside of the cylinder;
a piston rod that is coupled to the piston;
a rod guide for guiding the piston rod in a slidable manner by allowing the piston rod to be inserted through the rod guide, the rod guide being mounted to the cylinder; and
a locking mechanism that is actuated when the piston rod extends to reach a full extension position of the cylinder,
wherein the locking mechanism comprises:
a lock piston that is provided on the piston rod on the rod guide side with respect to the piston; and
a lock cylinder portion that is provided in the cylinder on a projecting end side of the piston rod and is provided to allow the look piston to be slidably inserted through the look cylinder portion,
wherein the lock piston comprises:
a flow path limiting-opening mechanism for limiting a flow path when the lock piston moves into the lock cylinder portion, and opening the flow path when the lock piston moves out of the lock cylinder portion;
a piston-side fixing portion for supporting the flow path limiting-opening mechanism from the piston side, the piston-side fixing portion being provided on an outer peripheral side of the piston rod; and
an annular rod-guide-side fixing member for restricting the flow path limiting-opening mechanism from moving to the rod guide side, the annular rod-guide-side fixing member being fitted in a groove that is formed along the piston rod, and
wherein the annular rod-guide-side fixing member comprises a radially shrinkable and expandable ring made of a metal material, the radially shrinkable and expandable ring being inserted along the piston rod with a gap on an inner peripheral side of the radially shrinkable and expandable ring, and being fitted into the groove by being pressed in a radial direction.

6. A cylinder device according to claim 1, wherein the annular rod-guide-side fixing member is formed integrally with a stopper for moderating impact on the rod guide.

7. A cylinder device according to claim 5, wherein the annular rod-guide-side fixing member is formed integrally with a stopper for moderating impact on the rod guide.

8. A manufacturing method for a cylinder device, the cylinder device comprising:
a cylinder in which working fluid is sealed;
a piston that is fit-inserted to be slidable in the cylinder and divides an inside of the cylinder;
a piston rod that is coupled to the piston;
a rod guide for guiding the piston rod in a slidable manner by allowing the piston rod to be inserted through the rod guide, the rod guide being mounted to the cylinder; and
a locking mechanism that is actuated when the piston rod extends to reach a full extension position of the cylinder,
the locking mechanism comprising:
a lock piston that is provided on the piston rod on the rod guide side with respect to the piston; and
a lock cylinder portion that is provided in the cylinder on a projecting end side ox the piston rod and is provided to allow the lock piston to be slidably inserted through the lock cylinder portion,
the lock piston comprising:
a flow path limiting-opening mechanism for limiting a flow path when the lock piston moves into the lock cylinder portion, and opening the flow path when the lock piston moves out of the lock cylinder portion;
a piston-side fixing portion for supporting the flow path limiting-opening mechanism from the piston side, the piston-side fixing portion being provided on an outer peripheral side of the piston rod; and
an annular rod-guide-side fixing member for restricting the flow path limiting-opening mechanism from, moving to the rod guide side, the annular rod-guide-side fixing member being fitted in a groove that is formed along the piston rod, the manufacturing method for the cylinder device comprising:
fixing the piston-side fixing portion to the piston rod after inserting the piston-side fixing portion from the piston side;
mounting the flow path limiting-opening mechanism, after inserting the flow path limiting-opening mechanism from the rod guide side; and
fixing the annular rod-guide-side fixing member by fitting the annular rod-guide-side fixing member into the groove after inserting the annular rod-guide-side fixing member from the rod guide side.
